(19) United States
(12) Patent Application Publication
(10) Pub. No.: US 2019/0226563 A1
(43) Pub. Date: Jul. 25, 2019

(54) RECTILINEAR DRIVE DEVICE

(71) Applicant: NIDEC SANKYO CORPORATION, Nagano (JP)

(72) Inventors: Hiroyuki HATASAKO, Nagano (JP); Takafumi KASUGA, Nagano (JP); Takahisa UEKI, Nagano (JP)

(73) Assignee: NIDEC SANKYO CORPORATION, Nagano (JP)

(21) Appl. No.: 16/337,919

(22) PCT Filed: Sep. 21, 2017
(86) PCT No.: PCT/JP2017/033997

§ 371 Date: Mar. 28, 2019

(30) Foreign Application Priority Data
Sep. 30, 2016 (JP) 2016-193159

(51) Int. Cl. F16H 25/24; F16H 25/20

(52) U.S. Cl. CPC F16H 25/24; F16H 2025/204; F16H 25/2006; F16H 25/2009

(57) ABSTRACT

To provide a rectilinear drive device capable of preventing or significantly suppressing a guide plate from swinging caused by a shake of a lead screw when the lead screw is shaken. Specifically, a lead screw driven and rotated by a motor, a nut threadedly engaged with the lead screw, a guide shaft arranged parallel to the lead screw, a regulating portion movably provided on the guide shaft and engaged with the outer periphery of the nut to regulate the rotation of the nut, and a slide plate formed with the wall portion configured to receive a thrust force of the nut from the end surface of the nut are included, and the end surface of the nut is provided with projections in line contact or point contact with the wall portion.

### TECHNICAL FIELD

The present invention relates to a rectilinear drive device for linearly moving a slider plate by rotation of a lead screw.

### BACKGROUND ART

As a conventional rectilinear drive device for reciprocating a moving body such as a guide plate in a rectilinear direction by converting a rotational motion of a motor into a rectilinear motion, for example, a known rectilinear drive device is as illustrated in FIG. 6 to FIG. 8 which includes a lead screw 11 driven and rotated by a stepping motor 10, a nut 12 threadedly engaged with the lead screw 11, a guide shaft 13 arranged parallel to the lead screw 11, and a slide plate 14 movably provided on the guide shaft 13 and formed with a U-shaped groove portion 15 through which the lead screw 11 and the nut 12 are inserted.

Here, the nut 12 is formed with flat cutout portions 12a on an outer peripheral surface at diametrically opposed positions, and these cutout portions 12a are positioned to be inserted between regulating walls (regulating portions) 16 forming opposed walls of the U-shaped groove portion 15 of the slide plate 14. As a result, the nut 12 is arranged in the groove portion 15 while rotation of the nut 12 is prevented.

Further, inside the slide plate 14, a U-shaped wall portion 17 is provided at a position opposed to an outer peripheral portion of both end surfaces of the nut 12.

As a result, according to the aforementioned rectilinear drive device, when the lead screw 11 is rotated by the stepping motor 10, the nut 12 prevented from being rotated by the regulating wall 16 moves in the rectilinear direction along the lead screw 11, and the thrust force is transmitted from the wall portion 17 to the slide plate 14, thereby the slide plate 14 can be rectilinearly moved along the guide shaft 13. It is noted that a configuration of this type of rectilinear drive device is also disclosed in, for example, below-described Patent Literature 1.

### CITATION LIST

### Patent Literature

Patent Literature 1: Japanese Unexamined Patent Application Publication No. 2013-151952

### SUMMARY

### Technical Problems

Incidentally, in the rectilinear drive device having the above configuration, for example, if a thrust load F is unceasingly applied in an arrow direction in the drawing from a side of the slide plate 14, the aforementioned thrust load F is applied on an end surface 12b of the nut 12 abutting against the wall portion 17 of the slide plate 14.

On the other hand, it is difficult for the lead screw 11 to be accurately rectilinearly formed in a manufacturing process, and in an actual product, slight deflection occurs. This results in a problem that when the lead screw 11 is rotated by the stepping motor 10, the lead screw 11 is shaken in a direction orthogonal to an axis caused due to the aforementioned deflection, and the shake of the lead screw 11 is transmitted to the slide plate 14 by a frictional force between the end surface 12b of the nut 12 and the wall portion 17 to swing the slide plate 14 around the guide shaft 13, leading to a malfunction in components connected to the slide plate 14.

The present invention has been made in view of the above circumstances, and an object thereof is to provide a rectilinear drive device capable of preventing or significantly suppressing a guide plate from swinging caused due to a shake of a lead screw when the lead screw is shaken.

### Solutions to Problems

To resolve the aforementioned problem, the present invention is a rectilinear drive device including: a lead screw driven and rotated by a motor; a nut threadedly engaged with the lead screw; a guide shaft arranged parallel to the lead screw; a regulating portion movably provided on the guide shaft and engaged with an outer periphery of the nut to regulate rotation of the nut; and a slide plate formed with a wall portion receiving a thrust force of the nut from an end surface of the nut, wherein protrusions in line contact or point contact with the wall portion are provided on the end surface of the nut.

According to the present invention, on the end surface of the nut through which the thrust force from the nut is transmitted via the wall portion of the slide plate, the protrusions in line contact or point contact with the wall portion are provided, and thus, the frictional force between the projections and the wall portion contacting each other is reduced. As a result, even if the lead screw is shaken, when slippage occurs between the projections and the wall portion of the slide plate, it is possible to prevent or significantly suppress the slide plate from swinging due to the shake of the lead screw.

Further, in the present invention, it is preferable that the end surface on which the protrusions are provided is an end surface on which a thrust load is applied from the slide plate side while in an operation stopped state.

According to the present invention, if the thrust load is applied from the slide plate side while in the operation stopped state, when the projections are provided only on the end surface of the nut in close contact with the wall portion of the slide plate, it is possible to obtain to an effect to surely prevent or suppress the slide plate from swinging.

Further, in the present invention, it is preferable that on the end surface of the nut, two projections projecting from the end surface in a columnar shape are formed. In this case, it is preferable that the projections are arranged such that a ridge line is positioned diametrically of the nut perpendicular to the regulating portion.

Further, in the present invention, it is preferable that the nut has flat cutout portions formed on an outer peripheral surface at diametrically opposed positions, the cutout portions are inserted to be positioned between the regulating portions, and when the cutout portions are inserted in opposition to the regulating portions, the projections are arranged such that the ridge line is positioned diametrically of the nut orthogonal to the regulating portion.

Further, in the present invention, it is preferable that on the end surface of the nut, three projections projecting spherically from the end surface are formed. In this case, it is preferable that the nut has flat cutout portions formed on an outer peripheral surface at diametrically opposed positions, the cutout portions are inserted to be positioned between the regulating portions, and the projections are formed at midpoints of portions of a circumference where the cutout portions are formed and at a position of the circumference intermediate in a circumferential direction between these midpoints.

Further, in the present invention, it is preferable that the slide plate is formed with a groove portion through which the lead screw and the nut are inserted, and the regulating portion is a regulating wall forming an opposing wall of the groove portion.

### Effect of the Invention

According to the present invention, on the end surface of the nut through which the thrust force from the nut is transmitted via the wall portion of the slide plate, the protrusions in line contact or point contact with the wall portion are provided, and thus, the frictional force between the projections and the wall portion contacting each other is reduced. As a result, even if the lead screw is shaken, when slippage occurs between the projections and the wall portion of the slide plate, it is possible to prevent or significantly suppress the slide plate from swinging due to the shake of the lead screw.

### BRIEF DESCRIPTION OF THE DRAWINGS

FIG. 1 is a side view illustrating a rectilinear drive device according to an embodiment of the present invention.

FIG. 2 is a perspective view illustrating a nut according to the embodiment of the present invention.

FIG. 3 is a front view illustrating the rectilinear drive device to which the nut of FIG. 2 is attached.

FIG. 4 is a perspective view illustrating a nut according to another embodiment of the present invention.

FIG. 5 is a front view illustrating the rectilinear drive device to which the nut of FIG. 4 is attached.

FIG. 6 is a side view illustrating a conventional rectilinear drive device.

FIG. 7 is a perspective view illustrating a nut of FIG. 6.

FIG. 8 is a front view of FIG. 6.

### MODE FOR CARRYING OUT THE INVENTION

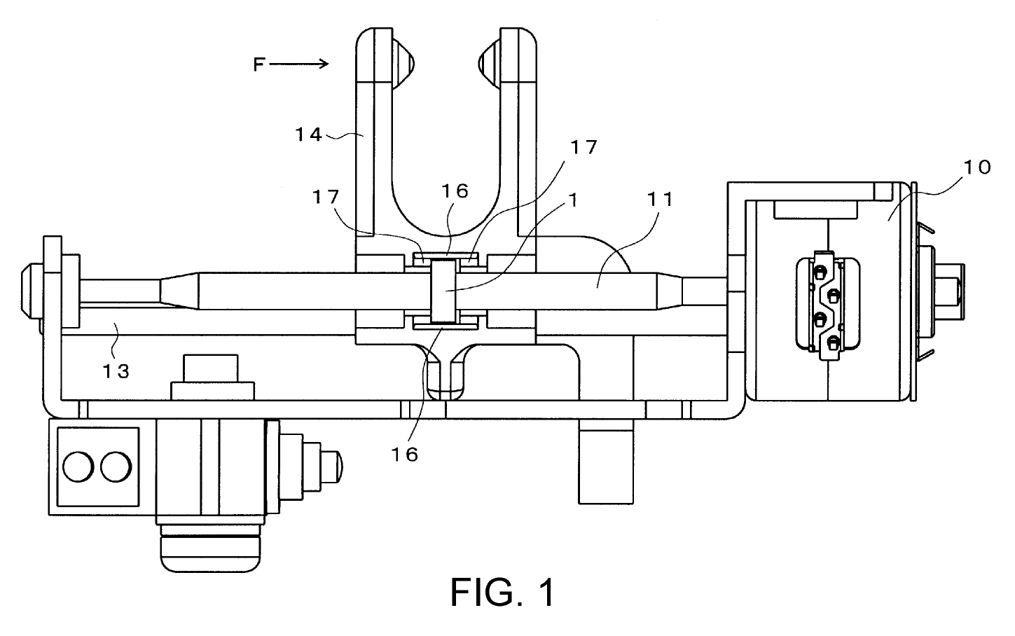

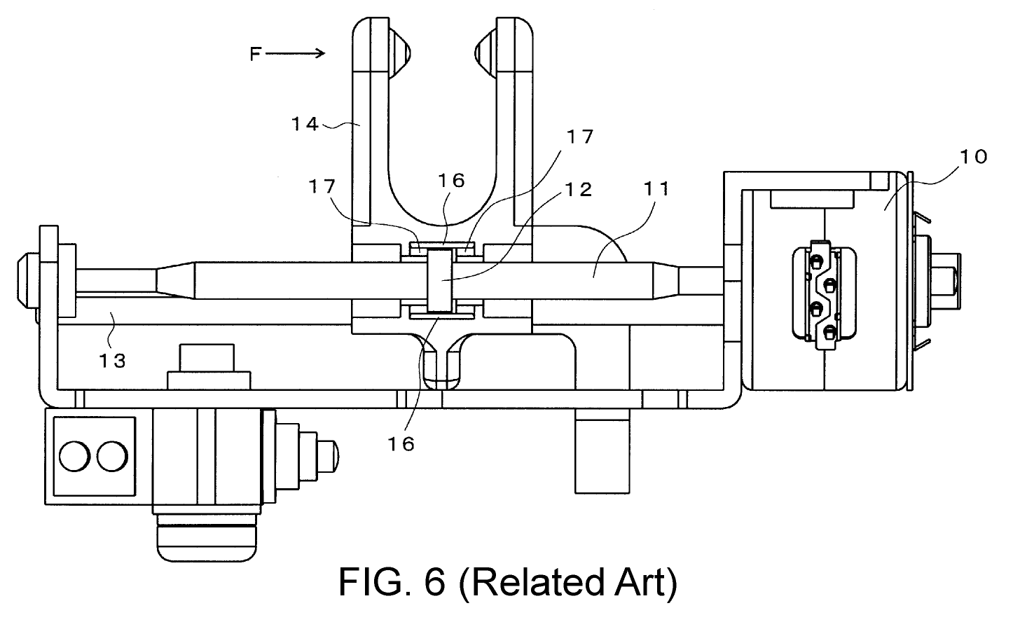

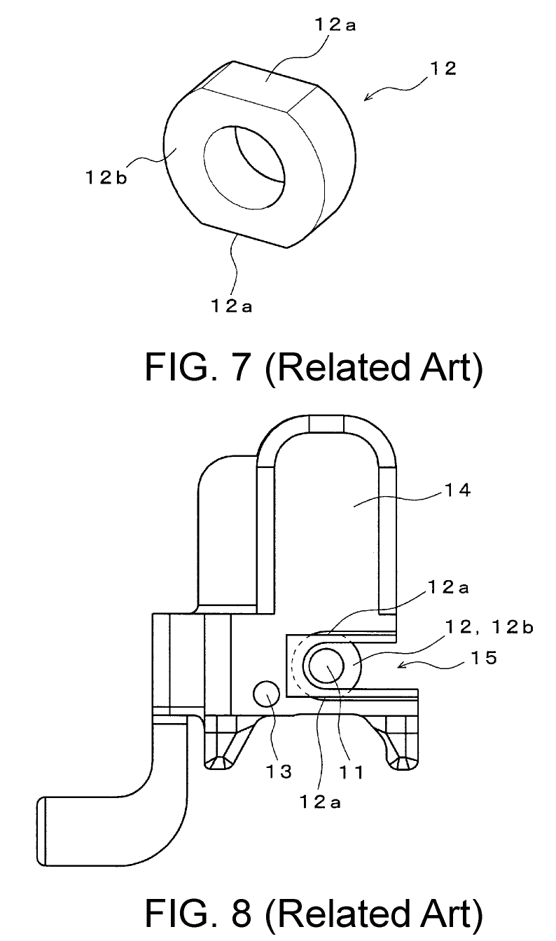

FIG. 1 to FIG. 3 illustrate one embodiment of a rectilinear drive device and a nut of the present invention. It is noted that constituent portions of the rectilinear drive device illustrated in FIG. 1 and FIG. 3 are the same as those illustrated in FIG. 6, except for the nut. Therefore, for the constituent portions other than the nut, the same reference numerals as in those in FIG. 6 are used for descriptions and illustrations.

As illustrated in FIG. 1 to FIG. 3, the rectilinear drive device of the present embodiment includes: the lead screw 11 driven and rotated by the motor 10, a nut 1 threadedly engaged with the lead screw 11, the guide shaft 13 arranged parallel to the lead screw 11, the regulating portion 16 movably provided on the guide shaft 13 and engaged with the outer periphery of the nut 1 to regulate the rotation of the nut 1, and the slide plate 14 formed with the wall portion 17 receiving a thrust force of the nut 1 from the end surface 1b of the nut 1. The slide plate 14 is formed with the U-shaped groove portion 15 through which the lead screw 11 and the nut 1 are inserted. The motor 10 of the present embodiment is a stepping motor. Further, the regulating portion 16 is a regulating wall forming the opposing wall of the U-shaped groove portion 15 of the slide plate 14.

The nut 1 is formed with flat cutout portions 1a on the outer peripheral surface at diametrically opposed positions, and these cutout portions 1a are positioned to be inserted between regulating walls (regulating portions) 16. As a result, the nut 1 is arranged in the groove portion 15 while rotation of the nut 1 is prevented. Further, inside the slide plate 14, the wall portion 17 is provided in a U shape at a position opposed to an outer peripheral portion of both end surfaces of the nut 1.

According to such a rectilinear drive device, when the lead screw 11 is rotated by the motor 10, the nut 1 prevented from being rotated by the regulating wall 16 moves in the rectilinear direction along the lead screw 11, the thrust force is transmitted from the wall portion 17 to the slide plate 14, and thus the slide plate 14 can be rectilinearly moved along the guide shaft 13.

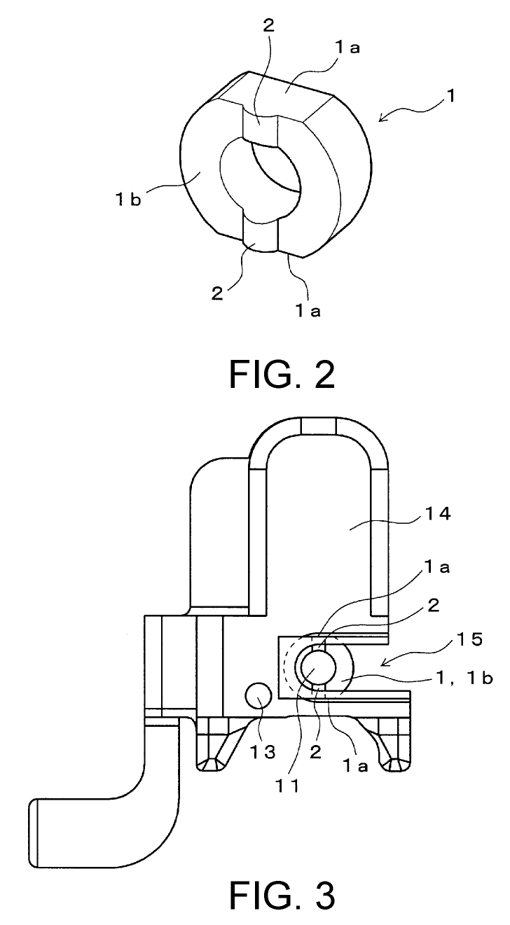

As illustrated in FIG. 2 and FIG. 3, in the rectilinear drive device, at the end surface 1b of the nut 1 on which the thrust load F is applied from the side of the slide plate 14 while in an operation stopped state, two projections 2 protruding in a columnar shape from the end surface 1b are integrally formed.

When the cutout portions 1a of the nut 1 are inserted in opposition to the regulating wall (regulating portion) 16 of the groove portion 15 of the slide plate 14, the projections 2 are arranged so that a ridge line is positioned diametrically of the nut 1 orthogonal to the regulating wall 16. Further, the projections 2 are formed on the end surface 1b of the nut 1 in a portion where the cutout portions 1a are formed. The projections 2 are formed to make line contact with the wall portion 17.

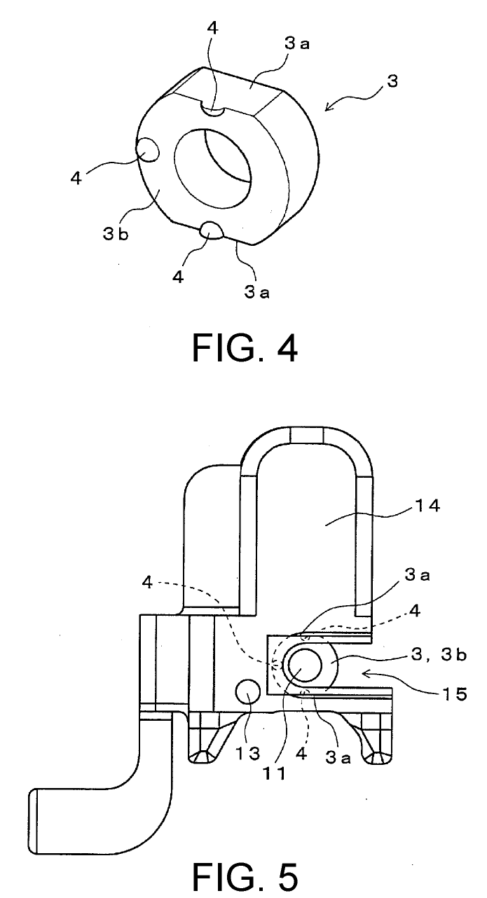

Further, FIG. 4 and FIG. 5 illustrate another embodiment of the present invention, and in this rectilinear drive device, at an end surface 3b of a nut 3 on which the thrust load F is applied from the side of the slide plate 14 while in an operation stopped state, three projections 4 protruding in a hemispherical shape from the end surface 3b are similarly integrally formed. The projections 4 are formed to make point contact with the wall portion 17.

Here, the projections 4 are formed at three positions equally spaced in the circumferential direction except the opening side of the groove portion 15, specifically, at a total of three positions, that is, at midpoints of portions of the circumference where the cutout portions 3a are formed and at a position of the circumference intermediate in the circumferential direction between these midpoints.

According to the rectilinear drive device having the aforementioned configuration, on the end surfaces 1b, 3b of the nuts 1, 3 through which the thrust force from the nuts 1, 3 is transmitted via the wall portion 17 of the slide plate 14, the protrusions 2 in linear contact with the wall portion 17 or the protrusions 4 in point contact with therewith are provided. Therefore, the frictional force between the protrusions 2, 4 and the wall portion 17 is reduced, and as a result, even if the lead screw 11 is shaken, when slippage occurs between the protrusions 2, 4 and the wall portion 17 of the slide plate 14 occurs, it is possible to prevent or significantly suppress the slide plate 14 from swinging caused due to the shake of the lead screw 11.

In particular, in the present embodiment, if the thrust load F is applied from the slide plate 14 side while in the operation stopped state, the projections 2, 4 are provided on the end surfaces 1b, 3b of the nuts 1, 3 closely contacting the wall portion 17 of the slide plate 14, and thus, it is possible to surely obtain an effect of preventing or suppressing the slide plate 14 from swinging.

It is noted that in the above embodiments, only a case that a structure where the cutout portions 1a, 3b are formed on the outer peripheral surface of the nuts 1, 3, and the regulating wall (regulating portion) 16 facing the cutout portion 1a, 3a is provided in the groove portion 15 of the slide plate 14 to prevent the rotation of the nuts 1, 3 is employed is described; however, the present invention is not limited thereto, and it is possible to adopt the regulating portion of various modes configured to prevent the rotation of the nuts 1, 3.

### DESCRIPTION OF REFERENCE NUMERALS

1, 3: nuts

1b, 3b: end surfaces

2, 4: projections

10: stepping motor (motor)

11: lead screw

13: guide shaft

14: slide plate

16: regulating wall (regulating portion)

17: wall portion

1. A rectilinear drive device, comprising:
a lead screw, driven and rotated by a motor;
a nut, threadedly engaged with the lead screw;
a guide shaft, arranged parallel to the lead screw;
a regulating portion, movably provided on the guide shaft and engaged with an outer periphery of the nut to regulate rotation of the nut; and
a slide plate, formed with a wall portion receiving a thrust force of the nut from an end surface of the nut, wherein
projections in line contact or point contact with the wall portion are provided on the end surface of the nut.

2. The rectilinear drive device according to claim 1, wherein
the end surface of the nut provided with the projections is an end surface on which a thrust load is applied from a side of the slide plate while in an operation stopped state.

3. The rectilinear drive device according to claim 1, wherein
on the end surface of the nut, two of the projections projecting from the end surface in a columnar shape are formed.

4. The rectilinear drive device according to claim 3, wherein
the projections are arranged such that a ridge line is positioned diametrically of the nut perpendicular to the regulating portion.

5. The rectilinear drive device according to claim 4, wherein
the nut has flat cutout portions formed on an outer peripheral surface at diametrically opposed positions,
the cutout portions are inserted to be positioned between the regulating portions, and
when the cutout portions are inserted in opposition to the regulating portions, the projections are arranged such that the ridge line is positioned diametrically of the nut orthogonal to the regulating portion.

6. The rectilinear drive device according to claim 1, wherein
on the end surface of the nut, three of the projections projecting spherically from the end surface are formed.

7. The rectilinear drive device according to claim 6, wherein
the nut has flat cutout portions formed on an outer peripheral surface at diametrically opposed positions,
the cutout portions are inserted to be positioned between the regulating portions, and
the projections are formed at midpoints of portions of a circumference where the cutout portions are formed and at a position of the circumference intermediate in a circumferential direction between these midpoints.

8. The rectilinear drive device according to claim 1, wherein
the slide plate is formed with a groove portion through which the lead screw and the nut are inserted, and
the regulating portion is a regulating wall forming an opposing wall of the groove portion.
